(19) United States
(12) Patent Application Publication
(10) Pub. No.: US 2026/0206057 A1
(43) Pub. Date: Jul. 16, 2026

(54) COORDINATING OPERATIONS AMONG MULTIPLE ACCESS POINTS WITHIN A MULTI-AP COORDINATION GROUP IN A COMMUNICATION NETWORK

(71) Applicant: Samsung Electronics Co., Ltd., Suwon-si (KR)

(72) Inventors: Abhishek CHATURVEDI, Bengaluru (IN); Karthik Srinivada GOPALAN, Bengaluru (IN); Anand JEE, Bengaluru (IN); Rishabh ROY, Bengaluru (IN)

(21) Appl. No.: 19/427,732

(22) Filed: Dec. 19, 2025

Related U.S. Application Data
(63) Continuation of application No. PCT/KR2025/015480, filed on Sep. 30, 2025.

(30) Foreign Application Priority Data
Oct. 4, 2024 (IN) 202441075300
Sep. 12, 2025 (IN) 202441075300

(51) Int. Cl. H04W 74/0816; H04W 8/00; H04W 74/04

(52) U.S. Cl. CPC H04W 74/0816; H04W 8/005; H04W 74/04

(57) ABSTRACT

A method for coordinating operations among multiple access points (APs) within a multi-AP coordination (MAPC) group in a communication network system is disclosed. The method may include detecting one or more neighbor APs of a plurality of APs. Further, the method may include forming the MAPC group including the AP and the one or more detected neighbor APs, coordinating with each other based on a coordination scheme during the pre-coordination duration. The AP and the one or more neighbor APs are restricted from leaving the MAPC group during the pre-coordination duration. Further, the method may include maintaining a post-coordination duration after the establishment of the MAPC group. The AP and the one or more neighbor APs are allowed to exit the MAPC group conditionally during the post-coordination duration.

### CROSS-REFERENCE TO RELATED APPLICATIONS

This application is a continuation of International Application No. PCT/KR2025/015480 designating the United States, filed on Sep. 30, 2025, in the Korean Intellectual Property Office and claiming priority to Indian Provisional Patent Application No. 202441075300, filed on Oct. 4, 2024, and Indian Complete patent application No. 202441075300, filed on Sep. 12, 2025, in the Indian Patent Office, the disclosures of each of which are incorporated by reference herein in their entireties.

### TECHNICAL FIELD

The disclosure relates to wireless communication network. For example, the present disclosure relates to coordinating operations among multiple access points within a multi-access point (multi-AP) coordination group in a wireless communication network.

### BACKGROUND

Wireless Local Area Networks (WLANs), particularly those adhering to the emerging Wi-Fi 8 standards, have increasingly focused on multi-Access Point (multi-AP) coordination. In multi-AP coordination, a plurality of Access Points (APs) is configured to discover neighboring APs, exchange coordination information, and engage in negotiation procedures to form a coordinated group. The primary objective of such a coordinated group of APs is to minimize co-channel interference and optimize channel utilization while satisfying Ultra-High Reliability (UHR) Key Performance Indicators (KPIs).

Several coordination schemes have been proposed for multi-AP coordination. These include Coordinated Access Points (C-AP), Coordinated Time Division Multiple Access (C-TDMA), Coordinated Orthogonal Frequency Division Multiple Access (C-OFDMA), Coordinated (restricted) Target Wakeup Time (C-(r) TWT), Coordinated Beamforming (C-BF), Coordinated Spatial Reuse (C-SR), and Coordinated Joint Transmissions (C-JT). A specific application of multi-AP coordination is in roaming scenarios where a client device transitions between non-collocated APs that are affiliated with the same mobility domain. In such scenarios, the goal is to enable near-lossless data roaming with minimal latency. To this end, Wi-Fi 8 standards have introduced techniques such as enhanced context transfer, signaling reduction, pre-authentication, and pre-configuration, thereby facilitating faster client association switching.

Within the IEEE 802.11 task group, two prominent multi-AP grouping architectures have emerged. A centralized architecture, suitable for enterprise deployments, includes discovery and negotiation among APs, followed by the selection of a group owner AP that manages coordination across the group. The group owner AP manages coordination across a multi-AP coordination (MAPC) group. “A group owner AP”, “a MAPC group owner AP”, “a coordinator AP”, and “a group owner or coordinator AP” are used interchangeably throughout this disclosure.

A distributed architecture, more suitable for residential or non-enterprise deployments, allows APs to advertise coordination capabilities, form coordination pairs with neighboring APs, and maintain multi-AP lists of coordination peers. In either architecture, the coordinated group of APs collectively seeks to improve wireless communication efficiency through organized cooperation.

Despite these structured approaches, several technical challenges remain. Multi-AP coordination typically relies on multiple pre-coordination steps, which can introduce signaling overhead. Such overhead increases the risk of network congestion, particularly in dense environments with a large number of APs. Further, the coordination within a multi-AP group is not indefinite. An AP may need to depart from the coordinated group due to varying operational conditions such as fluctuating transmission power levels, high power consumption, changes in coverage area, or the presence of high-priority low-latency traffic.

Currently, the IEEE 802.11 standard does not provide a comprehensive mechanism for determining when and how an AP should exit from an existing multi-AP coordinated group. The absence of such a mechanism creates inefficiencies in maintaining coordinated operations and impacts overall network performance.

The drawbacks/difficulties or the disadvantages/limitations of conventional techniques explained in the background section are simply examples and the disclosure does limit its scope only to such limitations. One skilled in the art would understand that this disclosure and below mentioned description may also address other problems or overcome the other drawbacks/disadvantages of the conventional arts which are not explicitly captured above.

The description set forth in the background section should not be assumed to be prior art merely because it is set forth in the background section. The background section may describe aspects or embodiments of the present disclosure.

### SUMMARY

Certain example embodiments may provide a method for coordinating operations among multiple access points (APs) within a multi-AP coordination (MAPC) group in a communication network system.

Certain example embodiments may provide a method to handle an AP leaving the MAPC group during the pre-coordination phase.

Certain example embodiments may provide a method to handle an AP leaving the MAPC group during the post-coordination phase.

Certain example embodiments may provide a method to handle an AP's leaving event from a MAPC group having short-term coordination schemes.

Certain example embodiments may provide a method to handle an AP's leaving event from a MAPC group having long-term coordination schemes.

Certain example embodiments may provide a method to handle an AP's leaving event from a MAPC group having mixed-term coordination schemes.

Certain example embodiments may provide a method to incorporate leniency mechanisms in multi-AP coordination policies.

Certain example embodiments may provide a method to bring in an element of urgency for the above-mentioned policies.

Certain example embodiments may provide a method for coordinating operations among multiple access points (APs) within a multi-AP coordination (MAPC) group in a communication network system. The method may include detecting by an Access Point (AP) of a plurality of APs one or more neighbor APs of the plurality of APs. Further, the method may include forming, by the AP, the MAPC group including the AP and the one or more detected neighbor APs coordinating with each other based on a coordination scheme during the pre-coordination duration. The AP and the one or more neighbor APs are restricted from leaving the MAPC group during the pre-coordination duration. Further, the method may include maintaining, by the AP, a post-coordination duration after the establishment of the MAPC group. The AP and the one or more neighbor APs are allowed to exit the MAPC group conditionally during the post-coordination duration.

In an example embodiment, the method may include determining, by the AP, a group owner or coordinator AP has not been decided yet for the MAPC group under formation. Further, the method may include performing, by the AP, one or more of remaining in the MAPC group until the completion of a pre-coordination duration when a group owner or coordinator AP has not been decided yet for the MAPC group under formation. Further, the method may include requesting permission to leave the MAPC group from the decided group owner or coordinator AP when the group owner or coordinator AP has been decided for the MAPC group during the pre-coordination duration. Further, the method may include requesting permission to leave the MAPC group from the group owner or coordinator AP during the post-coordination duration.

In an example embodiment, the method may include requesting permission to leave the MAPC group from the decided group owner or coordinator AP. Further, the method may include transmitting, by the AP, a coordination notification message to the group owner or coordinator AP before completion of the pre-coordination duration. The coordination notification message may include a cause value requesting exit from the MAPC group. Further, the method may include receiving, by the AP, a coordination response message from the one or more neighbor APs. The coordination response message may include a cause value indicating approval to exit the MAPC group when the coordination notification message is transmitted during the post-coordination duration.

In an example embodiment, the method may include detecting, by the AP, the one or more neighbor APs advertising, by the AP, capability to participate in M-AP coordination. Further, the method may include discovering, by the AP, the one or more neighbor APs that are capable of participating in the M-AP coordination based on the capability to participate in the M-AP coordination.

In an example embodiment, the method may include establishing, by the AP, the MAPC group. Further, the method may include initiating, by the APs, a first set of dedicated signaling exchanges to negotiate and agree for one or more M-AP coordination schemes supported by the plurality of APs. Further, the method may include establishing, by the AP, the MAPC group including the AP and the one or more detected neighbor APs based on the negotiated and agreed one or more M-AP coordination schemes.

In an example embodiment, the method may include preventing, by the AP, from leaving the MAPC group under formation until the completion of the pre-coordination duration. Further, the method may include allowing, by the AP, the one or more neighbor APs to leave the MAPC group under formation at any time before the start of a negotiation step without requiring any related indication. Further, the method may include preventing, by the AP, from leaving the MAPC group between the selection of group owner or coordinator AP and completion of the pre-coordination step towards the formation of the MAPC group to avoid disruption to ongoing agreements or negotiations.

In an example embodiment, the method may include determining, by the AP, whether the coordination scheme of the MAPC group may include only a short-term coordination scheme, only a long-term coordination scheme, or a mix of both short-term coordination scheme and long-term coordination scheme. Further, the method may include completion of the post-coordination duration is determined based on allowing participating AP to leave the MAPC group after the ending of a last Transmission Opportunity (TXOP) schedule of the MAPC group when the MAPC group may include only the short-term coordination scheme. The post-coordination duration is maintained till the ending of the last TXOP schedule of the MAPC group called as guard window when the coordination scheme is the short-term coordination scheme. Further, the method may include allowing the participating AP to leave the MAPC group after the ending of the last Service Period (SP) schedule of the MAPC group. The MAPC group may include only the long-term coordination scheme. The post-coordination duration is maintained till the end of the last SP schedule of the MAPC group called as guard window when the coordination scheme is the long-term coordination scheme. Further, the method may include allowing the participating AP to leave the MAPC group after the ending of the last schedule of the MAPC group whether it is a short-term or long-term schedule when the MAPC group may include both the short-term coordination scheme and the long-term coordination scheme. The post-coordination duration is maintained till the ending of the last schedule of the MAPC group called as guard window whether short or long when the coordination scheme is both the long-term coordination scheme and the short-term coordination scheme.

In an example embodiment, the method may include the AP transmits a coordination notification message to the MAPC group owner AP upon detection of MAPC group ownership, the message including a cause value indicating an exit intent. The MAPC group owner AP responds with a coordination reject message including a cause value “not allowed” and a backoff timer parameter to restrict further exit attempts until completion of the pre-coordination period.

In an example embodiment, the method may include the MAPC group owner AP transmits a coordination reject message including a cause value “not allowed” and a backoff timer parameter upon receiving the coordination notification message from the AP before the completion of the pre-coordination duration. The AP is restricted from sending repeated exit attempts until the expiry of the backoff timer.

In an example embodiment, the method may include upon detecting a departure of another AP from the MAPC group, the AP upon having ownership status initiates a re-negotiation process by transmitting a coordination notification message including a cause value “re-negotiation.” Further, the method may include redistributing coordination responsibilities among the remaining APs in the MAPC group. Further, the method may include enforcing a restriction on further departures from the MAPC group until completion of the re-negotiation process similar to restrictions enforced during the pre-coordination period.

In an example embodiment, the method may include the pre-coordination duration is maintained until completion of the MAPC group formation procedure.

In an example embodiment, the method may include the post-coordination duration is maintained until completion of a final transmission opportunity (TXOP) schedule when the MAPC coordination scheme is based on a short-term guard window schedule.

In an example embodiment, the method may include post-coordination duration is maintained until completion of a final service period (SP) schedule when the MAPC coordination scheme is based on a long-term guard window schedule.

In an example embodiment, the method may include the post-coordination duration is maintained until completion of the longest active schedule when the coordination scheme includes both short-term and long-term coordination schemes to confirm full-cycle protection in mixed-term coordination.

In an example embodiment, the method may include the AP is permitted to exit the MAPC group during the post-coordination duration upon determining an urgency condition that overrides normal restrictions.

In an example embodiment, the method may include the AP transmits a coordination notification message including a cause value “exit” and a sub-cause value “urgent.” The MAPC group owner immediately transmits a coordination response message indicating approval to leave without applying any condition check.

In an example embodiment, the method may include the coordination notification message includes a cause value “exit” and optionally may include a sub-cause value specifying a departure reason. The MAPC group owner AP transmits a coordination response message with a cause value indicating approval or rejection based on the departure condition for introducing leniency in handling of the coordination notification.

In an example embodiment, the method may include the sub-cause value in the coordination notification message indicates a leniency condition. The MAPC group owner AP compares the remaining guard window time within the post-coordination duration with an offset value associated with the sub-cause and allows early exit if the remaining time is less than or equal to the offset and otherwise transmits a coordination reject message with a backoff timer parameter.

The disclosure provides an access point (AP) coordinating operations among multiple access points (APs) within a multi-AP coordination (MAPC) group in a communication network system. The system may include a memory, at least one processor comprising processing circuitry, and at least one access point controller comprising circuitry. The at least one access point controller is coupled, directly or indirectly, to the memory and the at least one processor. The access point controller(s) detects one or more neighbor APs of the plurality of APs. Further, the access point controller(s) forms the MAPC group including the AP and the one or more detected neighbor APs coordinating with each other based on a coordination scheme during the pre-coordination duration. The AP and the one or more neighbor APs are restricted from leaving the MAPC group during the pre-coordination duration. Further, the access point controller(s) maintains a post-coordination duration after the establishment of the MAPC group. The AP and the one or more neighbor APs are allowed to exit the MAPC group conditionally during the post-coordination duration.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF DRAWINGS

The above other aspects, features, and advantages of certain embodiments of the present disclosure will be more apparent from the following detailed description taken in conjunction with the accompanying drawings in which like characters represent like parts throughout the drawings.

FIG. 1A is a schematic diagram that illustrates coordinated multi-Access Points (APs) according to the related art.

FIG. 1B is a schematic diagram that illustrates a centralized multi-AP (MAP) group setup according to the related art.

FIG. 1C is a schematic diagram that illustrates a distributed multi-AP (MAP) group setup according to the related art.

FIG. 2 is a sequence diagram that illustrates various stages of the M-AP coordination procedures in a unified framework according to the related art.

FIG. 3 is a schematic representation that illustrates a plurality of coordinated access points AP1, AP2, and AP3 managing interference in overlapping coverage areas according to the related art.

FIG. 4 is a block diagram that illustrates an AP coordinating operations among multiple APs within a multi-AP coordination (MAPC) group in a communication network system according to certain example embodiments.

FIG. 5 is a flowchart that illustrates an example method for coordinating operations among multiple APs within the MAPC group in a communication network system according to certain example embodiments.

FIG. 6 is a hierarchical flowchart that illustrates example coordinating operations among multiple access points (APs) within a multi-AP coordination (MAPC) group in a communication network system according to certain example embodiments.

FIG. 7 illustrates a sequence diagram for multi-access point coordination (MAPC) group formation with departure procedure handling during pre-coordination duration according to certain example embodiments.

FIGS. 8A, 8B, and 8C are example sequence diagrams that illustrate the flow of short-term coordination, long-term coordination, and mixed-term coordination respectively according to certain example embodiments.

FIG. 9 is a sequence diagram that illustrates example access point departure procedures in short-term, long-term, and mixed-term coordination schemes according to certain example embodiments.

FIG. 10 is a sequence diagram that illustrates example leniency implementation in multi-access point coordination group departure procedures according to certain example embodiments.

FIG. 11 is a sequence diagram that illustrates an example urgent departure mechanism within a Multi-AP Coordination (MAPC) framework according to certain example embodiments.

FIG. 12 is a sequence diagram that illustrates an example generic framework to handle a group-owner leaving the group according to certain example embodiments.

### DETAILED DESCRIPTION

The embodiments herein, along with their various features and advantageous details, are explained more fully with reference to the non-limiting embodiments illustrated in the accompanying drawings and detailed in the following description. Descriptions of well-known components and processing techniques are omitted to avoid unnecessarily obscuring the embodiments herein. Further, the various embodiments described are not necessarily mutually exclusive, as some embodiments can be combined with one or more other embodiments to form new embodiments. The term “or” as used herein refers to a non-exclusive “or” unless otherwise indicated. Examples provided are intended merely to facilitate an understanding of ways in which the embodiments herein can be practiced and to further enable those skilled in the art to practice the embodiments. Accordingly, these examples should not be construed as limiting the scope of the embodiments herein.

Whether a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.” For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items. The phrase “one or more of,” when used with a list of items, means that different combinations of one or more of the listed items may be used, and only one item in the list may be needed. For example, “one or more of: A, B, of C” includes any of the following combinations: A, B, C, A and B, A and C, B and C, and A and B and C.

Reference is made herein to some “embodiments.” It should be understood that an embodiment is an example of a possible implementation of any features and/or elements of the present disclosure. Various embodiments have been described for the purpose of explaining one or more of the potential ways in which the specific features and/or elements of the disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments are traditionally described and illustrated in terms of blocks that carry out specific functions. These blocks, referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. For example, the circuits may be embodied in one or more semiconductor chips or on substrate supports such as printed circuit boards. The circuits constituting a block may be implemented by dedicated hardware, by a processor (e.g., one or more programmed microprocessors and associated circuitry), or by a combination of dedicated hardware to perform functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method.

The accompanying drawings facilitate understanding of various technical features. The embodiments are not limited by these drawings and extend to any alterations, equivalents, and substitutes. Terms like “first,” “second,” etc., are used for distinction and do not limit the elements.

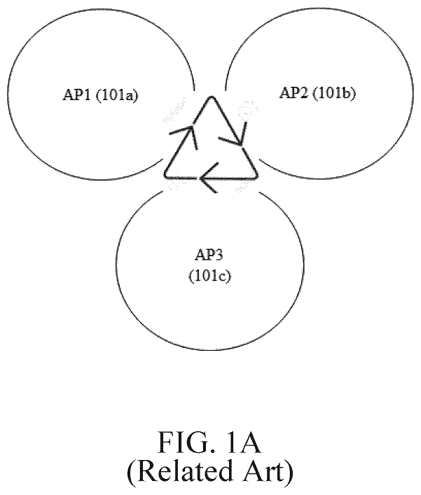

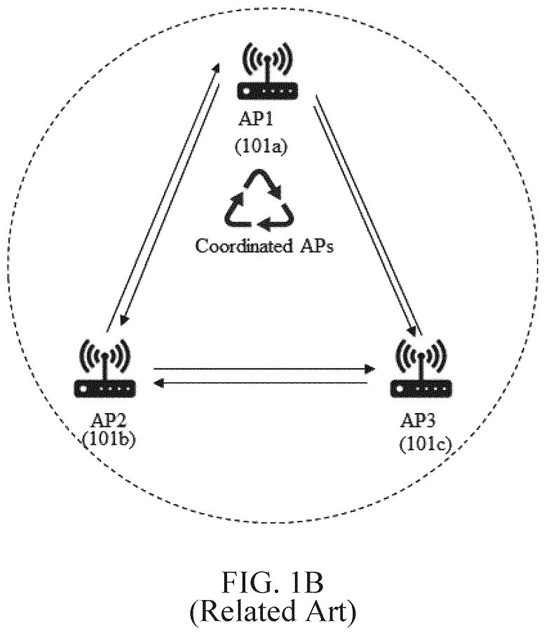

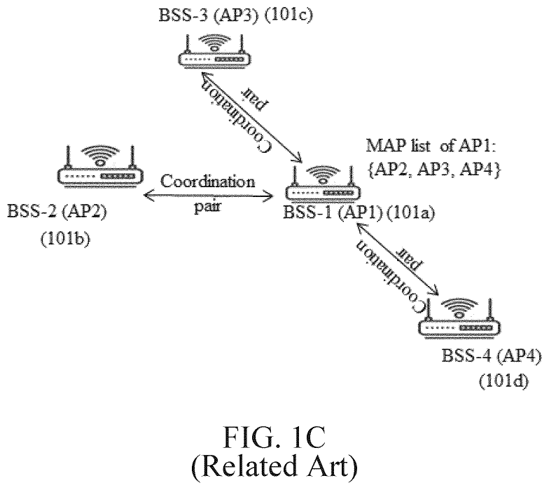

FIG. 1A is a schematic diagram illustrating coordinated multi-Access Points (APs) according to the related art. A plurality of Access Points (APs), namely AP1 (101a), AP2 (101b), and AP3 (101c), are represented as forming a coordinated group. Each AP (collectively referred to as 101) is capable of discovering neighboring APs, exchanging coordination information, and engaging in negotiation to establish cooperative operation. The arrows between the APs (101) represent the bidirectional exchange of coordination messages, enabling the APs (101) to share information related to scheduling, channel usage, interference management, and other coordination parameters necessary for group operation.

FIG. 1B is a schematic diagram illustrating a centralized multi-AP (MAP) group setup according to the related art. In this configuration, a single AP acts as a coordinator, managing coordination among all participating APs. This approach is particularly suitable for enterprise environments where a structured and controlled network is essential. The centralized architecture enables management of resources and coordination schemes, thereby ensuring that all APs are aligned in their operations.

In the flow of procedures illustrated in FIG. 1B for centralized grouping, the participating APs (101a-101c) first discover each other based on coordination capabilities broadcast in management frames such as Beacon frames. Once discovery is complete, a group-owner or coordinator AP (also referred to as a sharing AP) is selected to organize and manage coordination within the group. After negotiation and agreement-related signaling is completed, the coordinated group of APs is formed for one or more coordination schemes. In such a centralized setup, all participating APs are made aware of coordination information pertaining to every other AP in the group, thereby enabling consistent and synchronized operation.

FIG. 1C is a schematic diagram illustrating a distributed multi-AP (MAP) group setup by AP1 (101a) according to the related art. The distributed multi-AP (MAP) group setup of MAP grouping architecture is more suitable for non-enterprise or residential deployments. In this architecture, each AP (101) independently manages its coordination with neighboring APs (101b, 101c, 101d), thereby forming a decentralized network structure. Such a setup offers flexibility and scalability as APs (101) can dynamically join or leave the group without disrupting the overall coordination. However, since each AP (101) has visibility only into its immediate peers, maintaining consistent coordination across the network poses certain challenges. Despite these challenges, the distributed approach is well-suited for environments where network conditions are variable and less predictable, enabling a resilient and adaptable network infrastructure. In the context of wireless communication networks, the coordination among multiple APs is used for optimizing network performance and resource allocation. This optimization may include load balancing, interference management, and seamless handoff between APs to ensure uninterrupted connectivity for client devices. Further, the decentralized nature of the network allows for localized decision-making, which can be beneficial in scenarios where rapid adjustments to network conditions are required.

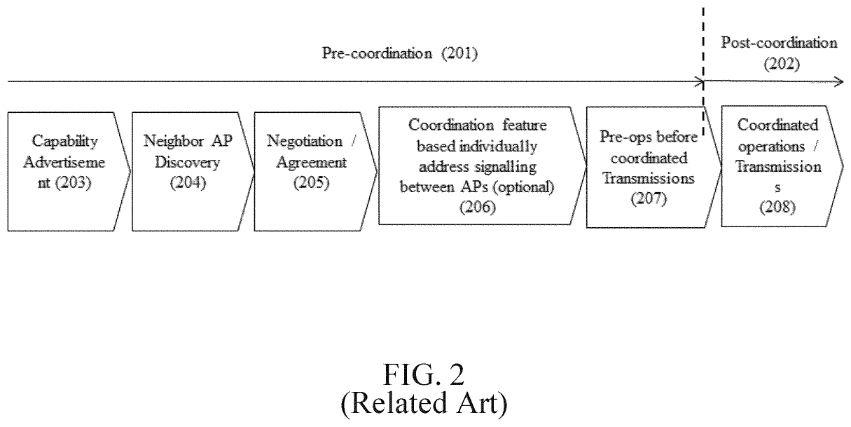

FIG. 2 is a sequence diagram that illustrates various stages of the M-AP coordination procedures in a unified framework according to the related art. Referring to FIG. 2, the unified framework represents a generic procedure for multi-AP coordination as discussed in ongoing IEEE 802.11 group contributions. The coordination procedures are broadly divided into two stages, namely a pre-coordination (201) stage and a post-coordination (202) stage. In the pre-coordination (201) stage, participating APs (101) perform a capability advertisement (203), a neighbor discovery (204), negotiations and agreements (205), and where applicable, coordination feature-specific individually addressed signaling (206). Additional signaling specific to coordination features may occur between APs, although this step is optional. Before the actual coordinated transmissions commence, pre-operations or preparations (207) are conducted to ensure that all participating APs are synchronized and ready for the coordinated activities. These preparations may include time synchronization, channel allocation, and power level adjustments to minimize or reduce interference and optimize throughput. The post-coordination (202) stage follows, during which actual coordinated operations and transmissions (208) are carried out among the APs until the termination of the coordination session. During this stage, APs may dynamically adjust their transmission parameters based on real-time network conditions and feedback from client devices to maintain optimal performance.

The Wi-Fi 8 standardization framework currently lacks a defined procedure for multi-access point coordination (M-APC) group departure. This deficiency forces access points to exit coordination groups by unilaterally ceasing adherence to negotiated parameters and reverting to independent operation. The absence of standardized leaving procedures creates a cascading technical deficiency. Departing access points that remain physically present generate uncoordinated interference by disregarding previously negotiated coordination agreements. Simultaneously, remaining group members continue operating under suboptimal resource constraints despite the departure. The persistent inefficient utilization of available coordination resources continues indefinitely until ad-hoc re-negotiation occurs, resulting in prolonged network performance degradation. This degradation can manifest as increased latency, reduced throughput, and higher packet loss rates, negatively impacting the user experience. Furthermore, the lack of a formal exit procedure can lead to network instability, as sudden changes in AP behavior may disrupt ongoing communications and degrade overall network reliability.

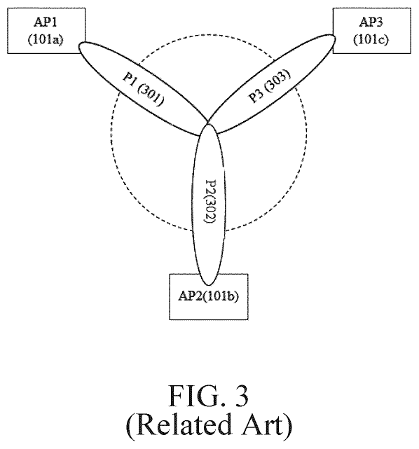

FIG. 3 is a schematic representation illustrating a plurality of coordinated access points (AP1, AP2, and AP3) managing interference in overlapping coverage areas according to the related art. In this figure, a coordinated spatial reuse (C-SR) implementation is depicted where access points (101) negotiate transmission power levels P1 (301), P2 (302), and P3 (303) respectively to maintain aggregate interference below a predetermined threshold T within a shared coverage area indicated by the dashed circular boundary. The coordination ensures that P1+P2+P3≤T to prevent or reduce interference for client devices operating within the overlapping region. However, upon the unplanned departure of AP3 from the coordination group, the remaining access points AP1 and AP2 continue operating under the previously negotiated constraints (P1+P2≤T-P3), resulting in suboptimal resource utilization. The absence of a coordination leaving procedure causes the remaining access points to maintain unnecessarily restrictive transmission parameters (T-P3) rather than adapting to the optimal available threshold (T), thereby reducing transmission efficiency and data throughput for associated client devices in the coordination region. This inefficiency can lead to increased contention and reduced network capacity, particularly in high-density environments where optimal resource allocation is critical for maintaining performance.

In an example embodiment, the multi-access point coordinated group is formed among two or more APs to minimize or reduce interference and optimize channel utilization along with other benefits via coordinated transmissions. The coordination is not an indefinite event, and there are scenarios which may cause a participating AP (101) to leave the group coordination. These scenarios include low transmission power levels, the need for further high transmission power levels, high power consumption, moving out of reachability of the group, or the ad hoc occurrence of high priority/low latency data traffic types. In the event of a participating AP3 (101c) abruptly leaving the M-APC group, the remaining members of the group (AP1, AP2) continue to operate under limited conditions according to previously negotiated terms, leading to inefficient resource utilization in each of the coordination schemes.

In the current IEEE 802.11 standard research for a unified framework for multi-AP coordination, including both academia and industry, the method of when and how a participating AP of an already existing multi-AP coordinated group can leave the coordinated multi-AP group has not been covered. This is a crucial case to handle; otherwise, upon an AP's departure from the coordinated group, the previously negotiated resources, including channel and transmission power that are shared among all participating APs, are not reorganized or distributed among the remaining APs. Consequently, the remaining APs are not able to reap the benefit of additional resources until later re-negotiations occur. To address the above limitation, there is a need for mechanisms that enable group formation, coordinated operation, and the departure of APs from a multi-AP group, thereby enhancing the efficiency, reliability, and performance of multi-AP coordination in WLANs operating under Wi-Fi 8 standards.

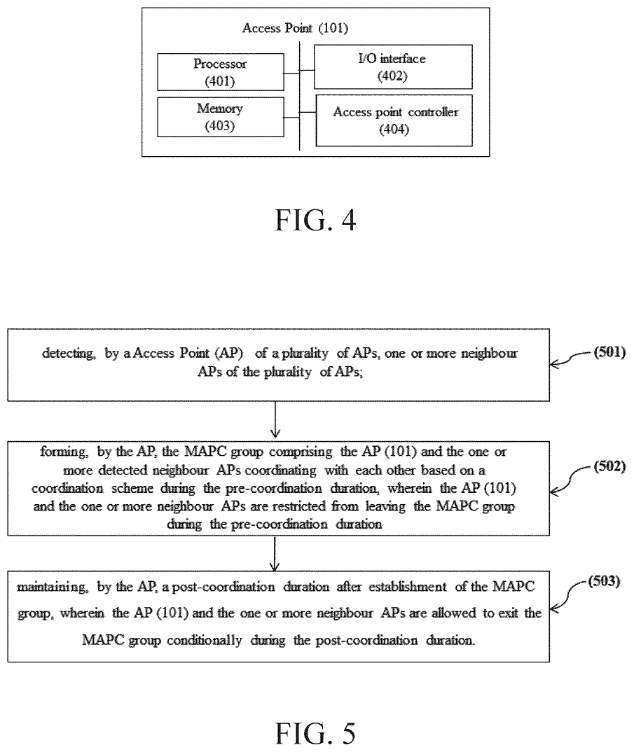

FIG. 4 is a block diagram illustrating an AP coordinating operations among multiple APs within a multi-AP coordination (MAPC) group in a communication network system according to embodiments disclosed herein. Examples of the AP (101) include, but are not limited to, wireless networking devices configured to provide connectivity to client devices within a Wireless Local Area Network (WLAN). Such APs encompass enterprise-grade APs deployed in office or campus environments, residential Wi-Fi routers, mesh networking nodes, hotspot devices, outdoor APs for public networks, industrial-grade APs for factory automation, vehicular APs for automotive or transportation systems, and specialized APs integrated into IoT gateways, public safety communication systems, or healthcare networks.

Examples of the wireless communication network system include, but are not limited to, Cellular Networks (such as 2G, 3G, 4G, 5G, Beyond 5G (B5G)/6G, or advanced cellular networks), Local Area Networks (LANs) (such as Wi-Fi, Li-Fi, etc.), Personal Area Networks (PANs) (such as Bluetooth, Zigbee, Z-Wave, etc.), Wide Area Networks (WANs) (such as Satellite Communication Networks, Long Range Wide Area Network, Narrowband IoT, Low-bandwidth communication for IoT, etc.), Metropolitan Area Networks (MANs), Machine-to-Machine (M2M), Ad Hoc and Mesh Networks, and Emerging and Advanced Networks.

The AP (101) may include a processor (401), a memory (403), an I/O interface (402), and an access point controller (404). The processor (401) executes instructions stored in the memory (403) to perform various processes. This processor (401) can include one or a plurality of processors and can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. The same applies to each “controller” herein. Additionally, the at least one processor may include a combination of processors performing various of the recited/disclosed functions, e.g., in a distributed manner. “At least one processor” herein, including the claims, may include a processor (401) and an access point controller (404). The same applies to each “controller” herein. At least one processor may execute program instructions to achieve or perform various functions. The same applies to each “controller” herein.

Further, the memory (403) of the AP (101) may include storage locations addressable through the processor (401). This memory (403) is not limited to volatile memory and/or non-volatile memory and can include one or more computer-readable storage media. Non-volatile storage elements within the memory (403) can include magnetic hard discs, optical discs, floppy discs, flash memories, or forms of electrically programmable memories (EPROM) or electrically erasable and programmable (EEPROM) memories. The memory (403) can store media streams such as audio streams, video streams, haptic feedbacks, and the like. The memory (403) stores instructions that, when executed by at least one processor individually or collectively, cause the AP (101) to perform the methods and/or the operations described herein. The at least one processor may include the combination of one or more processors such as the processor(s) (401), a CPU, GPU, MPU, an application processor (AP), and a communication processor (CP).

The I/O interface (402) transmits information between the memory (403) and external peripheral devices. Peripheral devices are the input-output devices associated with the AP (101). This I/O interface (402), comprising interface circuitry, receives several pieces of information from the network apparatus and may support various communication protocols such as Ethernet, USB, and wireless standards to facilitate seamless data exchange with connected devices and network components.

The access point controller (404) is coupled, directly or indirectly, to the processor (401) and memory (403) of the AP (101). This coupling enables data exchange and coordination control between the functional modules of the AP (101), ensuring that the Access Point Controller (404) can manage real-time operations associated with multi-AP coordination group formation and resource scheduling. The Access Point Controller (404) is an innovative integrated circuit implemented within the AP (101) designed to oversee centralized or distributed coordination tasks in a communication network system. In an example embodiment, the architecture of such an innovative integrated circuit may include a multi-core design that allows dynamic management of coordination capability advertisement, neighbor AP discovery, negotiation and agreement handling, MAP list maintenance, and coordination feature-specific signaling. Each core may be optimized for specific functions such as interference mitigation, channel utilization optimization, guard duration management, urgent departure handling, and group reconfiguration procedures. The innovative integrated circuit for coordination management may be composed of both analog and digital components to balance power consumption and processing efficiency. Analog components may include a low-noise amplifier and high-precision analog-to-digital converters for accurate signal measurements of wireless channels, while digital components may include a microcontroller unit (MCU) and a digital signal processor (DSP) that jointly manage coordination schemes, group membership updates, and transmission alignment across multiple APs in accordance with Wi-Fi 8 multi-AP coordination standards.

The access point controller (404) herein includes processing circuitry, and/or may include multiple processors. For example, as used herein, including the claims, the term “access point controller” may include various processing circuitry, including at least one processor, wherein one or more of at least one access point controller, individually and/or collectively in a distributed manner, may be configured to perform various functions described herein. As used herein, when “an access point controller”, “at least one access point controller”, and “one or more access control processors” are described as being configured to perform numerous functions, these terms cover situations, for example and without limitation, in which one access point controller performs some of recited functions and another processor(s) performs other of recited functions, and also situations in which a single processor/controller may perform all recited functions. Additionally, the at least one access point controller may include a combination of processors performing various of the recited/disclosed functions, e.g., in a distributed manner. At least one access point controller may execute program instructions to achieve or perform various functions. The access point controller may be controlled by the processor (401) or integrated into the processor (401).

The access point controller (404) detects one or more neighbor APs of the plurality of APs. Further, the access point controller (404) forms the MAPC group including the AP and the one or more detected neighbor APs, coordinating with each other based on a coordination scheme during the pre-coordination duration. The AP (101) and the one or more neighbor APs are restricted from leaving the MAPC group during the pre-coordination duration. The access point controller (404) maintains a post-coordination duration after the establishment of the MAPC group. The AP (101) and the one or more neighbor APs are allowed to exit the MAPC group conditionally during the post-coordination duration.

The access point controller (404) determines whether a group owner or coordinator AP (101) has been decided for the MAPC group under formation. If a group owner or coordinator AP has not been decided, the access point controller (404) remains in the MAPC group until the completion of the pre-coordination duration. When a group owner or coordinator AP has been decided, the access point controller (404) requests permission to leave the MAPC group from the decided group owner or coordinator AP during both the pre-coordination and post-coordination durations.

The access point controller (404) transmits a coordination notification message to the group owner or coordinator AP before the completion of the pre-coordination duration. This coordination notification message may include a cause value requesting exit from the MAPC group. Upon receiving the coordination notification message, the access point controller (404) receives a coordination response message from the one or more neighbor APs, which may include a cause value indicating approval to exit the MAPC group when the coordination notification message is transmitted during the post-coordination duration.

The access point controller (404) advertises its capability to participate in M-AP coordination and discovers the one or more neighbor APs capable of participating in the M-AP coordination based on this capability. This discovery process may include scanning for available APs, evaluating their capabilities, and establishing initial communication links to facilitate coordination.

The access point controller (404) establishes the MAPC group and initiates the first set of dedicated signaling exchanges to negotiate and agree on one or more M-AP coordination schemes supported by the plurality of APs. The MAPC group, including the AP (101) and the one or more detected neighbor APs, is established based on the negotiated and agreed-upon M-AP coordination schemes. These schemes may include parameters for channel allocation, transmission power levels, and timing synchronization to ensure coordination.

The access point controller (404) prevents leaving the MAPC group under formation until the completion of the pre-coordination duration. However, the one or more neighbor APs are allowed to leave the MAPC group under formation at any time before the start of a negotiation step without requiring any related indication. The access point controller (404) prevents leaving the MAPC group between the selection of the group owner or coordinator AP and the completion of the pre-coordination step to avoid disruption to ongoing agreements or negotiations. This prevention mechanism may include temporary restrictions and monitoring to ensure compliance with coordination protocols.

The access point controller (404) determines whether the coordination scheme of the MAPC group may include only a short-term coordination scheme, only a long-term coordination scheme, or a combination of both short-term and long-term coordination schemes. The completion of the post-coordination duration is further determined based on the identified coordination scheme. The access point controller (404) allows the participating AP to leave the MAPC group after the ending of the last Transmission Opportunity (TXOP) schedule of the MAPC group when the MAPC group includes only the short-term coordination scheme. This guard window ensures that all coordinated transmissions are completed before any AP exits the group.

The access point controller (404) transmits a coordination notification message to the MAPC group owner AP upon detection of MAPC group ownership, the message including a cause value indicating an exit intent. The MAPC group owner AP responds with a coordination reject message including a cause value “not allowed” and a backoff timer parameter to restrict further exit attempts until the completion of the pre-coordination period. This reject message may also include suggestions for alternative actions or adjustments to address the exit intent.

Upon receiving the coordination notification message from the AP (101) before the completion of the pre-coordination duration, the MAPC group owner AP transmits a coordination reject message including a cause value “not allowed” and a backoff timer parameter. The AP (101) is restricted from sending repeated exit attempts until the expiry of the backoff timer. This restriction helps maintain stability and prevent or reduce frequent disruptions during the coordination process.

Upon detecting a departure of another AP from the MAPC group while holding ownership status, the access point controller (404) initiates a re-negotiation process by transmitting a coordination notification message including a cause value of re-negotiation. This process redistributes coordination responsibilities among the remaining APs (101) in the MAPC group and enforces a restriction on further departures until the completion of the re-negotiation process, similar to the restrictions enforced during the pre-coordination period. This re-negotiation process ensures that the remaining APs can adapt to the new network topology and maintain optimal performance.

The access point controller (404) maintains the pre-coordination duration until the completion of the MAPC group formation procedure. This duration may include multiple steps such as capability advertisement, neighbor discovery, and initial negotiations to ensure all APs are ready for coordinated operations.

The access point controller (404) maintains the post-coordination duration until the completion of a final transmission opportunity (TXOP) schedule when the MAPC coordination scheme is based on a short-term guard window schedule. This schedule ensures that all coordinated transmissions are completed before any AP exits the group.

The access point controller (404), comprising circuitry, maintains the post-coordination duration until the completion of a final Service Period (SP) schedule when the MAPC coordination scheme is based on a long-term guard window schedule. This schedule ensures that all long-term coordinated operations are completed before any AP exits the group.

The access point controller (404) maintains the post-coordination duration until the completion of the longest active schedule when the coordination scheme includes both short-term and long-term coordination schemes, thereby ensuring full-cycle protection in mixed-term coordination. This approach ensures that all coordinated operations are completed before any AP exits the group.

The access point controller (404) permits the AP (101) to exit the MAPC group during the post-coordination duration upon determining an urgency condition that overrides normal restrictions. This condition may include critical network requirements.

FIG. 5 is a flowchart that illustrates a method for coordinating operations among multiple APs within the MAPC group in a communication network system according to certain example embodiments.

At 501, the method may include detecting one or more neighbor APs of a plurality of APs in the communication network by the AP (101). The detection process may include scanning the wireless environment to identify APs operating on the same or adjacent channels. This can be achieved using techniques such as passive scanning, where the AP listens for beacon frames from neighboring APs, or active scanning, where the AP sends probe requests and listens for probe responses or via unicast or broadcast MAPC discovery request and MAPC discovery response based signaling procedures. The detected APs are then evaluated based on signal strength, channel utilization, and other relevant metrics to determine their suitability for inclusion in the MAPC group.

At 502, the method may include forming the MAPC group including the AP (101) and the one or more detected neighbor APs coordinating with each other based on a coordination scheme during the pre-coordination duration by the AP (101). The AP (101) and the one or more neighbor APs are restricted from leaving the MAPC group during the pre-coordination duration. The coordination scheme may include synchronizing transmission schedules, sharing channel state information, and implementing interference mitigation strategies. During this phase, the APs exchange control messages to establish common parameters and agree on the coordination rules. The pre-coordination duration ensures that all APs are aligned and ready to operate in a coordinated manner before any data transmission begins.

At 503, the method may include maintaining a post-coordination duration after establishment of the MAPC group by the AP (101). The AP (101) and the one or more neighbor APs are allowed to exit the MAPC group conditionally during the post-coordination duration. The conditions for exit may include criteria such as completion of ongoing data transmissions, availability of alternative coordination groups, or predefined time intervals. The post-coordination duration allows for dynamic adjustments to the group composition while maintaining overall network performance. This phase also may include monitoring the performance of the coordination scheme and making necessary adjustments to optimize network efficiency.

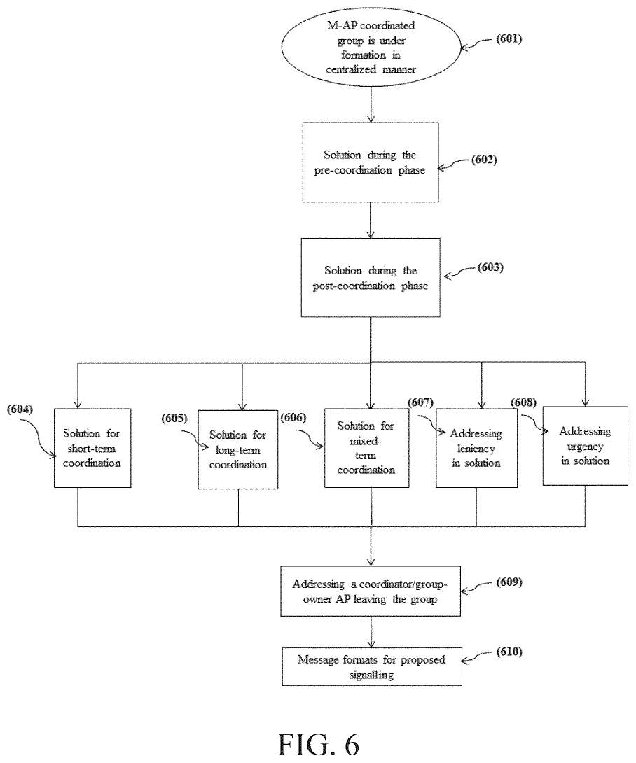

FIG. 6 is a hierarchical flowchart that illustrates coordinating operations among multiple access points (APs) within a multi-AP coordination (MAPC) group in a communication network system according to certain example embodiments.

At 601, the M-AP coordinated group is under formation, where AP (101) detects one or more neighbor APs and forms the MAPC group including the AP and the detected neighbor APs coordinating with each other based on a coordination scheme. The MAPC group formation process may include a designated coordinator AP that manages the group formation and coordination activities. This AP collects information from all participating APs, such as their capabilities, current load, and channel conditions, to make informed decisions about group composition and coordination strategies.

At 602, solution during the pre-coordination phase is implemented. The AP (101) and the one or more neighbor APs are restricted from leaving the MAPC group during the pre-coordination duration until completion of the MAPC group formation procedure. This phase may include detailed planning and negotiation among the APs to establish the coordination framework. The APs exchange messages to agree on parameters such as transmission schedules, power levels, and interference management techniques. The pre-coordination phase ensures that all APs are synchronized and ready to operate in a coordinated manner before any data transmission begins.

At 603, solution during the post-coordination phase is maintained. Further, the AP and the one or more neighbor APs are allowed to exit the MAPC group conditionally during the post-coordination duration. The conditions for exit may include criteria such as completion of ongoing data transmissions, availability of alternative coordination groups, or predefined time intervals. The post-coordination phase allows for dynamic adjustments to the group composition while maintaining overall network performance. This phase also may include monitoring the performance of the coordination scheme and making necessary adjustments to optimize network efficiency.

At 604, solution for short-term coordination is executed where participating APs are allowed to leave after ending of the last Transmission Opportunity (TXOP) schedule. The short-term coordination scheme focuses on immediate and short-duration transmission opportunities, typically lasting a few milliseconds. This scheme is suitable for applications requiring quick and frequent data exchanges, such as real-time communication and interactive services. The APs coordinate their transmission schedules to minimize or reduce collisions, and maximize or improve channel utilization during these short bursts of activity.

At 605, solution for long-term coordination is implemented where departure is permitted after ending of the last Service Period (SP) schedule. The long-term coordination scheme may include extended-duration service periods, typically lasting several milliseconds to seconds. This scheme is suitable for applications requiring sustained data transmission, such as video streaming and large file transfers. The APs coordinate their transmission schedules to ensure continuous and reliable data flow over these longer periods, optimizing network performance and reducing interference.

At 606, solution for mixed-term coordination allows departure after ending of the last schedule whether short-term or long-term. The mixed-term coordination scheme combines elements of both short-term and long-term coordination, allowing APs to handle a variety of traffic types and transmission requirements. This scheme provides flexibility in managing network resources, enabling APs to switch between short-term and long-term coordination as needed. The APs coordinate their schedules to accommodate both immediate and sustained data transmission needs, ensuring balanced network operation.

At 607, addressing leniency in solution is performed through sub-cause values and offset comparisons with remaining guard window time. The leniency mechanism allows for flexibility in handling AP departures, accommodating unforeseen circumstances without compromising overall coordination. Sub-cause values provide detailed reasons for departure requests, and offset comparisons help determine the appropriate response based on the remaining guard window time. This approach ensures that departures are managed smoothly, minimizing or reducing disruption to the coordination group.

At 608, addressing urgency in solution is implemented where urgent departure requests with sub-cause value “urgent” override normal restrictions. The urgency mechanism prioritizes critical departure requests, ensuring that the group can quickly adapt to changes and maintain performance. Urgent requests are evaluated based on their impact on network operation, and appropriate actions are taken to accommodate these requests while preserving overall coordination. This approach ensures that the network remains responsive to high-priority needs, maintaining optimal performance.

At 609, addressing a coordinator/group-owner AP leaving the group is handled through re-negotiation processes and responsibility redistribution among remaining APs. When the coordinator or group-owner AP needs to leave the group, a re-negotiation process is initiated to redistribute coordination responsibilities among the remaining APs. This process may include selecting a new coordinator, updating coordination parameters, and ensuring that all APs are aligned with the new coordination framework. This approach ensures that the group remains stable and continues to operate despite the departure of the original coordinator.

At 610, message formats for proposed signaling are incorporated including coordination notification messages with cause values and coordination response messages for approval or rejection of departure requests. The message formats define the structure and content of coordination-related messages exchanged among APs. Coordination notification messages include cause values that specify the reason for departure requests, while coordination response messages provide approval or rejection of these requests. This standardized messaging framework ensures clear and communication among APs, facilitating smooth coordination and departure processes.

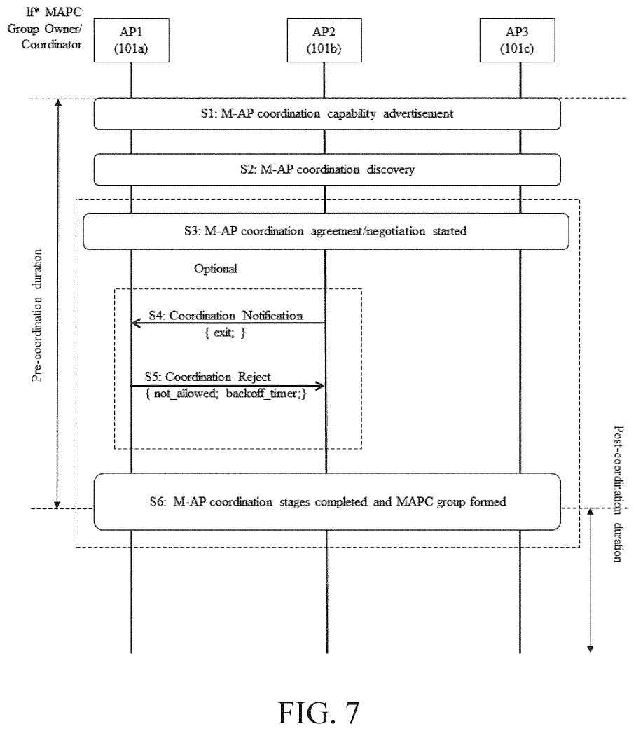

FIG. 7 illustrates a sequence diagram for multi-access point coordination (MAPC) group formation with departure procedure handling during pre-coordination duration according to certain example embodiments. The FIG. 7 discloses three access points AP1 (101a), the AP2 (101b), and the AP3 (101c), where AP1 (101a) serves as the MAPC group owner or the coordinator.

At S1, the M-AP coordination capability advertisement is performed by the access points to advertise their capability to participate in M-AP coordination. This step may include broadcasting capability information, such as supported coordination schemes, available resources, and performance metrics. The advertisement helps neighboring APs identify potential coordination partners and assess their suitability for group formation.

At S2, the M-AP coordination discovery is executed by the access points to discover one or more neighbor APs that are capable of participating in the M-AP coordination based on the advertised capabilities. Further, participating APs are permitted to leave the group-under-formation without requiring any related indication. The discovery process may include scanning the wireless environment and exchanging discovery messages to identify compatible APs. This step ensures that the group is formed with APs that can effectively coordinate and contribute to overall network performance.

At S3, the M-AP coordination agreement or negotiation is started through the first set of dedicated signaling exchanges between the access points to achieve agreement and negotiation for one or more M-AP coordination schemes as supported by the participating access points. The pre-coordination duration encompasses steps S1 through S6, during which access points are restricted from leaving the group after negotiation commencement to avoid disruption to ongoing agreements. The negotiation process may include exchanging detailed information about coordination parameters, such as transmission schedules, power levels, and interference management techniques. This step ensures that all APs are aligned and ready to operate in a coordinated manner.

At S4, an optional coordination notification message is transmitted by a departing access point (e.g., AP2) to the group owner or coordinator AP (e.g., AP1 (101a)) with a cause value “exit” to request permission to leave the MAPC group during the pre-coordination duration. This optional signaling mechanism represents option2 scenario where the group owner or coordinator AP has been decided as opposed to option1 where no departure attempts are made when the group owner/coordinator has not been determined. The notification message may include detailed information about the departure request, such as the reason for departure and the proposed timing. This step ensures that the group owner is aware of the departure request and can make an informed decision.

At S5, a coordination reject message is sent in response by the group owner AP with cause value “not allowed” and a backoff_timer parameter to prevent or reduce repeated exit requests until completion of the pre-coordination duration. The reject message may include detailed information about the rejection, such as the reason for rejection and the backoff timer value. This step ensures that the departing AP is aware of the rejection and can adjust its behavior accordingly.

At S6, the M-AP coordination stages are completed, and a MAPC group is formed, marking the transition from the pre-coordination duration to the post-coordination duration where conditional departure is permitted according to the established coordination schemes and guard window parameters. The completion of the coordination stages may include finalizing all coordination parameters and ensuring that all APs are aligned and ready to operate in a coordinated manner. This step marks the beginning of the post-coordination phase, where the group operates according to the established coordination schemes.

In an example embodiment, Option 1 restricts any AP from leaving the group until the pre-coordination phase is complete if the group owner or coordinator has not yet been determined, ensuring that the foundational structure of the group remains intact during formation. Option 2 provides a more nuanced approach by allowing an AP to request permission to leave from the designated group owner or coordinator AP through the coordination notification message, including a cause value explaining the departure reason. The group owner assesses the feasibility of this request and responds with the coordination reject message if necessary, including a backoff timer to prevent or reduce repeated requests. This mechanism introduces leniency and flexibility, accommodating unforeseen circumstances while prioritizing the stability of the coordination group.

Further, once the pre-coordination phase is successfully completed, the system transitions into the post-coordination phase characterized by coordinated channel operations where the APs (101) engage in synchronized data transmissions. The completion of all relevant signaling and the formal establishment of the MAPC group mark the beginning of this phase. The coordinated operations enhance the overall efficiency and performance of the network as the APs (101) work in unison to manage data flows and reduce interference. This underscores the importance of structured coordination in modern wireless networks, providing a framework that balances flexibility with the need for stability and efficiency in multi-AP environments.

In addition, the post-coordination phase mainly may include coordinated channel operations, including data transmissions by the participating APs, and starts immediately after the completion of all relevant signaling and MAPC group formation. The coordinated channel operations include synchronized transmission schedules, power level adjustments, and interference management techniques to optimize network performance. This phase ensures that all APs operate in a coordinated manner, maximizing or improving channel utilization, and minimizing or reducing interference.

In an example embodiment, the concept of a Guard Window for maintaining the integrity and efficiency of a coordinated Multi-Access Point (M-AP) group has been disclosed. The Guard Window is a designated period immediately following the formation of an M-AP group during which no external Access Points (APs) are allowed to join the group. This period prevents or reduces any immediate disruptions to the established coordination, ensuring that all participating APs can operate according to the agreed-upon schemes. By allowing a lean time for these APs, the Guard Window enables optimal channel utilization through coordinated transmission, thereby maximizing or improving the benefits of the time, signaling, and processing resources invested in achieving group coordination. The initial stability ensures seamless functioning of the network as it respects the collaborative efforts of all participating APs in maintaining communication environment.

Building upon the foundational policies of the Guard Window, the embodiment addresses scenarios involving a participating AP's decision to leave the coordinated group. Five specific scenarios are identified, each requiring tailored solutions to manage the departure of the AP (101) from the Multi-Access Point Coordination (MAPC) group. These scenarios include handling the departure of an AP from groups with short-term, long-term, and mixed-term coordination schemes. Each scenario presents unique challenges and demands specific strategies to ensure that the remaining APs continue to function optimally. In short-term coordination schemes, the focus is on quickly redistributing resources to minimize or reduce disruption, whereas in long-term schemes, the emphasis is on maintaining the integrity of the established coordination over an extended period. Mixed-term schemes require a hybrid approach, balancing immediate adjustments with long-term considerations.

In an example embodiment, there may be provided elements of leniency and/or urgency. Leniency allows for flexibility in handling AP departures, accommodating unforeseen circumstances without compromising the overall coordination through grace periods or temporary adjustments in resource allocation to ease the transition. Urgency emphasizes the need for swift action in critical situations, ensuring that the group can quickly adapt to changes and maintain performance. This dual approach ensures that the policies are robust yet adaptable, capable of addressing a wide range of scenarios while preserving the benefits of coordinated operation. During the post-coordination duration, no AP leaves the group without the consent of the group-owner or coordinator AP. Unauthorized departures could lead to failure in reorganizing or redistributing the negotiated resources, such as channel bandwidth or transmission power, among the remaining APs (101), preventing them from benefiting from additional resources until further negotiations occur, underscoring the importance of structured and consensual transitions within the group.

In an example embodiment, the short-term coordination refers to coordination schemes with limited duration transmission opportunities. If the MAPC group consists of or comprises only short-term coordination schemes, then a participating AP (101) may be allowed to leave the MAPC group after ending of the last TXOP (Transmission Opportunity) schedule of the group. The post-coordination duration is maintained until the end of the last TXOP schedule of the MAPC group, called the guard window, when the coordination scheme is the short-term coordination scheme. Further, the long-term coordination refers to coordination schemes with extended duration service periods. If the MAPC group consists of only long-term coordination schemes, then a participating AP shall be allowed to leave the MAPC group after ending of the last SP (Service Period) schedule of the group. The post-coordination duration is maintained until the end of the last SP schedule of the MAPC group, called the guard window, when the coordination scheme is the long-term coordination scheme. Further, mixed-term coordination refers to coordination schemes combining both short and long duration elements. If the MAPC group consists of both short-term and long-term coordination schemes, then a participating AP shall be allowed to leave the MAPC group after ending of the last schedule of the group, whether it is a short-term or long-term schedule. The post-coordination duration is maintained until the end of the last schedule of the MAPC group, called the guard window, whether short or long, when the coordination scheme is both the long-term coordination scheme and the short-term coordination scheme.

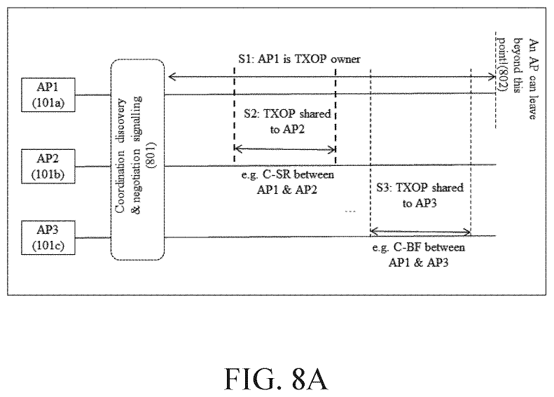

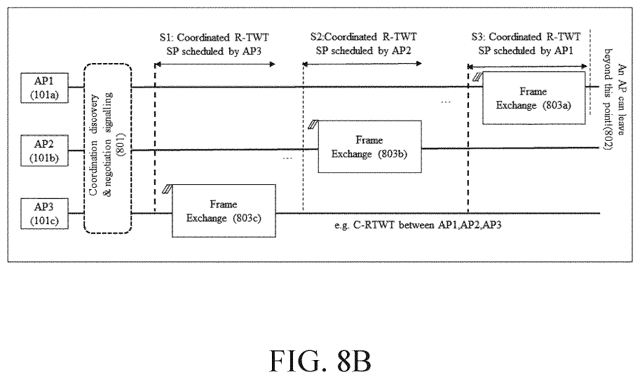

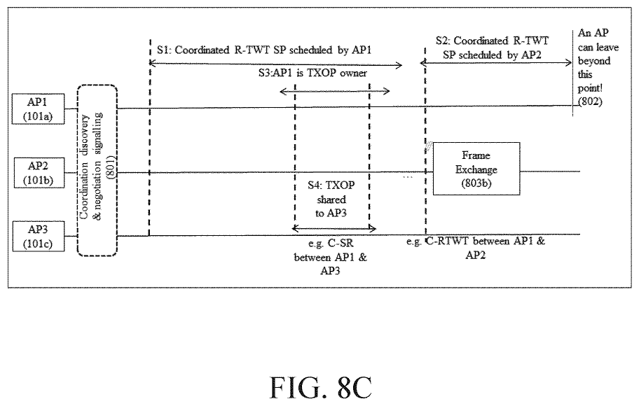

FIG. 8A through 8C are sequence diagrams that illustrate the flow of Short-Term Coordination, Long-Term Coordination, and Mixed-Term Coordination, respectively, according to certain example embodiments.

FIG. 8A is a sequence diagram that illustrates an example flow of short-term coordination scheme during the coordination discovery signaling and negotiation signaling phase (801). The short-term coordination scheme is valid for Transmission Opportunity durations (TXOP), which are typically 3-4 ms long, are termed short-term coordination schemes. For example, Coordinated Spatial Reuse (C-SR). This scheme focuses on optimizing channel utilization during short bursts of activity, ensuring that APs can quickly and exchange data without causing interference. In an example embodiment, the sequence demonstrates TXOP sharing where S1 represent the AP1 (101a) as a TXOP owner, S2 represents TXOP shared to the AP2 (101b) for C-SR coordination, and S3 represents the TXOP shared to AP3 (101c) for C-BF coordination. The AP (101) may leave beyond point (802) after completion of all the TXOP schedules.

FIG. 8B is a sequence diagram that illustrates an example flow of long-term coordination scheme during the coordination discovery signaling and negotiation signaling phase (801). The long-term coordination scheme is typically designed for Service Periods (SP) lasting around 16 milliseconds for example, thus categorized as long-term coordination. An example of such a coordination scheme is the Coordinated Restricted Target Wake Time (C-rTWT), which allows for scheduling and power management by coordinating the wake-up times of devices in a network. This coordination ensures that devices are active when necessary, thereby conserving energy and optimizing network performance. The long-term coordination scheme focuses on sustained data transmission, ensuring reliable and continuous communication over extended periods. The AP (101) may leave beyond this point (802) after completion of all scheduled Service Periods, with frame exchanges (803a-803c) occurring between the coordinated APs during the respective coordination activities.

In an example embodiment, the sequence represents three phases of C-rTWT coordination. The S1 represent Coordinated R-TWT Service Period scheduled by the AP3 (101c) with a frame exchange (803c), the S2 represents Coordinated R-TWT Service Period scheduled by the AP2 (101b) with frame exchange (803b), and S3 represents Coordinated R-TWT Service Period scheduled by AP1 (101a) with frame exchange (803a). The sequential Service Periods enable coordinated wake-up scheduling and power management across all participating APs (101a-101c) in the MAPC group.

FIG. 8C illustrates a sequence diagram that illustrates a mixed-term coordination where the APs within a MAPC group are engaged in both short-term and long-term coordination schemes simultaneously during the coordination discovery signaling and negotiation signaling phase (801). This approach allows for flexibility in managing network resources, as APs handle immediate short-term data transmission needs through TXOP-based coordination, while others focus on strategic long-term coordination through Service Period schedules. The mixed-term coordination demonstrates how these dual coordination strategies operate within a MAPC group, highlighting the complexity of managing multiple coordination schemes concurrently and requiring departure procedures that accommodate the longest active schedule to ensure complete coordination cycle protection. The AP (101) may leave beyond the designated point (802) after the completion of all scheduled coordination activities.

In an example embodiment, the mixed-term coordination sequence demonstrates four coordination phases. S1 represents Coordinated R-TWT Service Period scheduled by the AP1 (101a) for long-term coordination, S2 represents Coordinated R-TWT Service Period scheduled by the AP2 101b for sustained communication, S3 illustrates the AP1 (101a) acting as TXOP owner for short-term coordination, and S4 depicts TXOP shared to the AP3 101c enabling C-SR coordination between the AP1 (101a) and the AP3 (101c). The frame exchange (803b) occurs between the AP1 (101a) and the AP2 (101b) during the C-RTWT coordination, illustrating how both long-term Service Period scheduling and short-term TXOP sharing operate simultaneously within the same MAPC group to optimize network resource utilization.

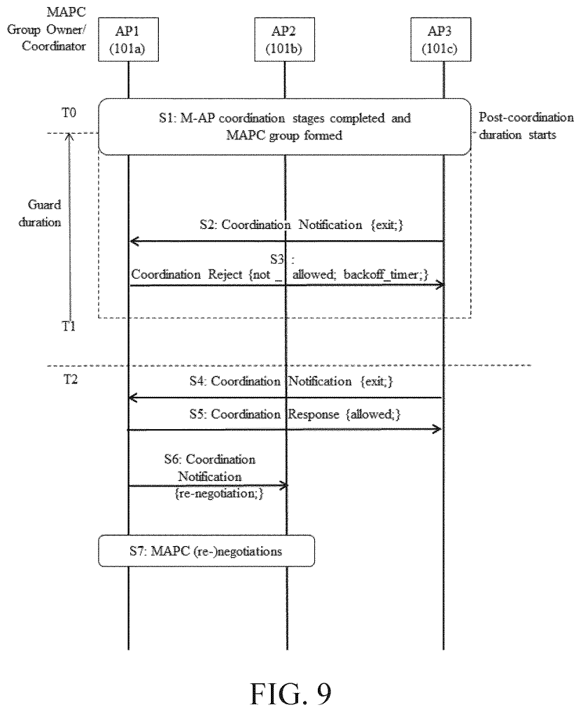

FIG. 9 is a sequence diagram that illustrates access point departure procedures in the short-term, the long-term, and the mixed-term coordination schemes according to certain example embodiments. The FIG. 9 represents the APs (101) departure procedures in the short-term, long-term, and mixed-term coordination schemes within the multi-access point coordination group, representing the guard window implementation and conditional exit mechanisms based on the specific coordination scheme duration and scheduling parameters. “Based on” as used herein covers based at least on.

At S1, the AP1 (101a) functioning as group-owner or coordinator, AP2 (102b), and AP3 (101c) formed a MAPC group at time T0 with all interested coordination schemes, and the last TXOP/SP schedule of the group ends at time T1. The group formation may include detailed planning and negotiation among the APs to establish the coordination framework, ensuring that all APs are aligned and ready to operate in a coordinated manner.

At S2, the AP3 (101c) determines the requirement to depart the group and transmits the coordination notification message to the AP1 (101a), including cause value “exit”. The notification message may include detailed information about the departure request, such as the reason for departure and the proposed timing. This step ensures that the group owner is aware of the departure request and can make an informed decision.

At S3, since the departure request is received prior to termination of guard duration at T1, the AP1 (101a) transmits the coordination reject message to the AP3, including cause value “not_allowed” along with the backoff timer parameter to prevent or reduce chances of the AP3 (101c) from transmitting repeated departure requests until completion of time T1. The reject message may include detailed information about the rejection, such as the reason for rejection and the backoff timer value. This step/operation ensures that the departing AP is aware of the rejection and can adjust.

At S4, at a later point T2 beyond the time T1 (and potentially after expiry of any backoff_timer received earlier), the AP3 (101c) again decides to leave the group and transmits a coordination notification message to AP1 (101a) including cause value “exit.”

At S5, since the guard duration at T1; has already elapsed, the AP1 (101a) permits the AP3 (101c) to leave the group by transmitting the coordination response message including cause value “allowed.” This confirmation authorizes the AP3 (101c) to depart from the MAPC group.

At S6, after the AP3 (101c) has left the group, the coordination scheme(s) in which the AP3 (101c) previously participated require re-negotiation to ensure fair reorganization of resources among the remaining APs. Accordingly, AP1 (101a) notifies the affected AP(s), such as AP2 (101b), by transmitting the coordination notification message including cause value “re-negotiation.”.

At S7, the affected APs (101), including the AP1 (101a) and the AP2 (101b), enter into the re-negotiation process. During the re-negotiation, restrictions on departure are re-applied in a manner similar to the pre-coordination phase, ensuring stability until the updated coordination process is complete.

In an example embodiment, the solutions proposed in the previous sections, including the coordination schemes, the GW policies for short, long, or mixed-term schemes, and handling of the AP leaving in short, long, or mixed-term coordination schemes, are stringent in nature in order to safeguard the channel and processing resources as well as to maintain the ongoing benefits of coordination among participating APs. However, certain exceptional conditions (Leniency) may arise that necessitate allowing a participating AP to terminate the coordination prematurely.

For example, a participating Access Point (AP), such as a battery-powered mobile AP, may determine, upon reaching an internal power threshold, that it must reduce its power consumption and is therefore unable to continue complying with the negotiated terms of the ongoing coordination, thereby requiring early termination of its participation.

In another example, the participating AP may encounter unexpected high-priority or low-latency (LL) traffic that necessitates either extended channel occupancy or a transition from a low-capability state to a high-capability state, as a result of which the AP (101) is unable to continue meeting the negotiated terms of the coordination and accordingly seeks to leave the coordination prematurely.

Accordingly, even though a guard duration is defined for a specific coordination group to address cases where the participating AP leaves the group in an ad hoc manner, provision shall also be made to incorporate leniency within the solution. An optional field referred to as a “sub-cause” may be included in association with the cause value field of the coordination notification message transmitted by the leaving AP to the group-owner AP, thereby enabling indication of the specific sub-cause for leaving. Each such standard-defined sub-cause value has a mapped offset time duration to it as shown in the below Table 1.

TABLE 1

| sub-cause | offset (us/ms) |
|---|---|
| power_saving | value_0 |
| LL_traffic | value_1 |
| . . . | . . . |

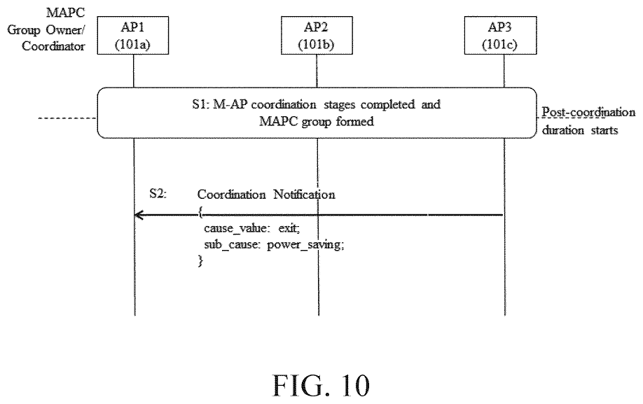

FIG. 10 is a sequence diagram that illustrates the leniency implementation in multi-access point coordination group departure procedures. FIG. 10 discloses the MAPC Group Owner or Coordinator AP1 (101a), AP2 (101b), and AP3 (101c).

At S1, the M-AP coordination stages are completed and the MAPC group is formed, marking the commencement of post-coordination duration. At S2, AP3 (101c) transmits the coordination notification message to AP1 (101a) including the cause_value “exit” and sub_cause “power_saving,” representing the leniency mechanism for early departure requests based on specific departure conditions.

In an example embodiment, the usage of sub-cause and offset are disclosed. When the participating AP3 (101c) transmits the coordination notification message to group-owner AP1 (101a) with the intention to depart the group, the message may include the cause value as “exit” and optionally may include a sub-cause value. When the sub-cause value is included, AP1 (101a) matches the sub-cause to the corresponding offset duration. The offset value can be expressed in microseconds or milliseconds. If the remaining time for the guard duration to expire is less than or equal to the offset duration of the sub-cause, AP1 (101a) transmits the coordination response to AP3 (101c) with the cause “allowed,” thereby permitting early departure from the group followed by any necessary re-negotiations within the group. When the conditions are not satisfied, AP1 (101a) transmits the coordination reject to AP3 (101c) with the cause “not_allowed” and may include the parameter backoff_timer.

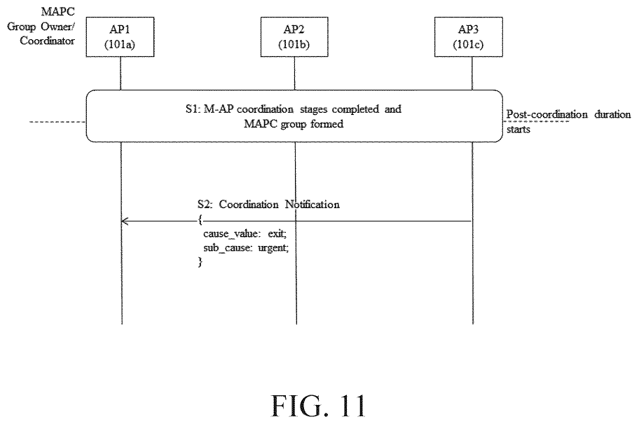

FIG. 11 is a sequence diagram that illustrates an urgent departure mechanism within a Multi-AP Coordination (MAPC) framework according to certain example embodiments. Further, FIG. 11 represents a critical protocol exception that allows immediate exit from coordinated operations under emergency circumstances.

At S1, the M-AP coordination stages are successfully completed and the MAPC group is fully operational, marking the commencement of the post-coordination duration phase. During normal operations, participating APs (101) are expected to maintain their coordinated behavior according to established parameters and guard durations.

At S2, the post-coordination duration period may be initiated. During this phase, all participating APs (101) are expected to maintain their coordinated behavior according to the established operational parameters, including guard durations, transmission schedules, and interference mitigation protocols. The AP controller operates under normal coordination rules where any departure requests would typically undergo standard validation procedures, including compliance with guard duration requirements and proper exit condition verification. The stable operational state serves as the baseline from which emergency departure procedures, such as the urgent exit mechanism demonstrated in following stages, represent protocol exceptions designed to handle unforeseen circumstances that cannot accommodate normal departure timelines.

In an example embodiment, when the group-owner AP1 (101a) receives the coordination notification having a cause value of exit and a sub-cause value of urgent, the request is processed in accordance with urgent departure handling as disclosed herein. While both stringent and lenient approaches may be adopted for handling a participating AP's departure request, certain exceptional cases necessitate immediate exit from the coordinated group regardless of the guard duration status. By way of example, a participating AP (e.g., a mobile AP) that is under mobility and about to move beyond the communication range of the group may be required to notify and exit the group immediately. All such immediate departure scenarios are collectively categorized under an optional sub-cause value of urgent as illustrated in Table 2. Table 2 discloses the sub-cause and its corresponding offset time duration.

TABLE 2

| sub-cause | offset (us/ms) |
|---|---|
| power_saving | value_0 |
| LL_traffic | value_1 |
| . . . | . . . |
| urgent | N/A |

When the group-owner AP1 (101a) receives the coordination notification with a cause value of “exit” and a sub-cause value of “urgent,” AP1 (101a) bypasses any additional condition checks. It responds with a coordination response message indicating the cause is allowed to the requesting AP (e.g., AP3), thereby permitting an urgent departure. Subsequent re-negotiations, if required, may then be performed within the group to re-establish coordination.

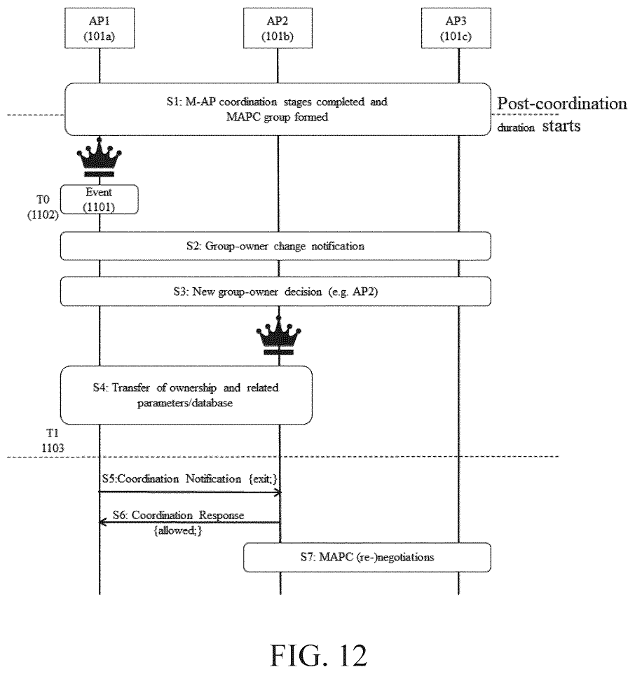

FIG. 12 is a sequence diagram that illustrates a generic framework for handling a group-owner leaving the group according to the disclosed embodiments.

At S1, the coordinated group is formed among AP1 (101a), AP2 (101b), and AP3 (101c), with AP1 (101a) acting as the group-owner.

At S2, at time T0 (1102), an event (1101) occurs that triggers the initiation of procedures leading to the group-owner AP leaving the coordinated group.

At S3, the group-owner change notification is transmitted to each participating AP.

At S4, a group-based decision is made to determine the next group-owner or coordinator.

At S5, upon deciding that AP2 (101b) may act as the new group-owner, AP1 (101a) transfers the related parameters and database to AP2 (101b) for further handling.

At S6, at time T1 (1103), AP1 (101a) notifies the new group-owner AP2 (101b) of its intent to leave the group by transmitting the coordination notification message.

At S7, AP2 (101b) responds with the coordination response message, allowing AP1 (101a) to exit the MAPC group, followed by any re-negotiations within the group as required.

The event identification in S2 is designed to ensure there is enough time (T0 to T1) for all the signaling related to S3 to S6 to complete before AP1 (101a) moves out of the coordinated group.

Further, three coordination-related messages are introduced in the sequence of a participating AP leaving the existing MAPC group. The details of each message are illustrated in Table 3.

TABLE 3

| Message Name | Contents | | |
|---|---|---|---|
| Coordination Notification | { | | |
| (sent by leaving AP to | | • | shall at least include a cause value: |
| group-owner AP) | | | {exit; re-negotiation; etc.} |
| | | • | may optionally include a sub-cause |
| | | | value: {power_saving; LL_traffic; |
| | | | urgent; etc.} |
| | | • | message can be extended to repurpose |
| | | | it for other MAP cases as well such as |
| | | | a new AP joining the existing MAPC |
| | | | group. |
| | } | | |
| Coordination Response | { | | |
| (sent by group-owner AP | | • | shall at least include ‘allowed’ |
| to leaving AP) | | | response |
| | | • | message can be extended to repurpose |
| | | | it for other MAP cases as well such as |
| | | | a new AP joining the existing MAPC |
| | | | group. |
| | } | | |
| Coordination Reject | { | | |
| (sent by group-owner AP | | • | shall at least include ‘not allowed’ |

| | |
|---|---|
| to leaving AP) | response |

| • | shall at least include a ‘backoff timer’ |
|---|---|
| | field to indicate leaving AP to wait for |
| | this much time before re-trying to |
| | leave this group |
| • | message can be extended to repurpose |

it for other MAP cases as well such as
a new AP joining the existing MAPC
group.

}

The methods disclosed in the above may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

One or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the various embodiments described herein. The term “computer-readable medium” may be understood to include tangible items and exclude carrier waves and transient signals, e.g., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

One aspect of the disclosure provides an access point (AP) comprising at least one processor including processing circuitry. The AP comprises memory storing instructions that, when executed by the at least one processor individually or collectively, cause the AP to detect one or more neighbor APs. The instructions, when executed by the at least one processor individually or collectively, cause the AP to form a multi AP coordination (MAPC) group comprising the AP and the one or more detected neighbor APs coordinating with each other based on a coordination scheme during the pre-coordination duration. The AP and the one or more neighbor APs are restricted from leaving the MAPC group during the pre-coordination duration. The instructions, when executed by the at least one processor individually or collectively, cause the AP to maintain a post-coordination duration after establishment of the MAPC group for a period of time. The AP and the one or more neighbor APs are allowed to exit the MAPC group conditionally during the post-coordination duration.

In an example embodiment, the instructions, when executed by the at least one processor individually or collectively, cause the AP to determine a group owner AP has not been decided yet for the MAPC group under formation. The instructions, when executed by the at least one processor individually or collectively, cause the AP to perform one of: remaining in the MAPC group until the completion of a pre-coordination duration, when the group owner AP has not been decided yet for the MAPC group under formation, requesting permission to leave the MAPC group from the decided group owner AP, when the group owner AP has been decided for the MAPC group during the pre-coordination duration, and/or requesting permission to leave the MAPC group from the group owner AP during the post-coordination duration.

In an example embodiment, the requesting permission to leave the MAPC group from the decided group owner AP comprises transmitting a coordination notification message to the group owner AP before completion of the pre-coordination duration. The coordination notification message comprises a cause value requesting exit from the MAPC group. The requesting permission to leave the MAPC group from the decided group owner AP comprises receiving a coordination response message from the one or more neighbor APs. The coordination response message comprises a cause value indicating approval to exit the MAPC group when the coordination notification message is transmitted during the post-coordination duration.

In an example embodiment, the detecting the one or more neighbor APs comprises advertising capability to participate in M-AP coordination. The detecting the one or more neighbor APs comprises discovering the one or more neighbor APs that are capable of participating in the M-AP coordination based on the capability to participate in the M-AP coordination.

In an example embodiment, the forming the MAPC group comprises initiating a first set of dedicated signaling exchanges to negotiate and agree for one or more M-AP coordination schemes supported by the plurality of APs. The forming the MAPC group comprises establishing the MAPC group comprising the AP and the one or more detected neighbor APs based on the negotiated and agreed one or more M-AP coordination schemes.

In an example embodiment, the instructions, when executed by the at least one processor individually or collectively, cause the AP to allow the one or more neighbor APs to leave the MAPC group under formation at any time before start of a negotiation step, without requiring any related indication. The instructions, when executed by the at least one processor individually or collectively, cause the AP to prevent from leaving the MAPC group between the selection of group owner AP and completion of the pre-coordination step towards formation of the MAPC group to avoid disruption to ongoing agreements or negotiations.

In an example embodiment, the instructions, when executed by the at least one processor individually or collectively, cause the AP to determine whether a coordination scheme of the MAPC group comprises only a short-term coordination scheme, only a long-term coordination scheme, and/or a mix of both short-term coordination scheme and long-term coordination scheme. The completion of the post-coordination duration is determined based on: (1) allowing participating AP to leave the MAPC group after the ending of a last Transmission Opportunity (TXOP) schedule of the MAPC group, when the MAPC group comprises only the short-term coordination scheme, wherein the post-coordination duration is maintained till ending of the last TXOP schedule of the MAPC group, called as guard window, when the coordination scheme is the short-term coordination scheme, (2) allowing the participating AP to leave the MAPC group after the ending of the last Service Period (SP) schedule of the MAPC group, when the MAPC group comprises only the long-term coordination scheme, wherein the post-coordination duration is maintained till ending of the last SP schedule of the MAPC group, called as guard window, when the coordination scheme is the long-term coordination scheme, and/or (3) allowing the participating AP to leave the MAPC group after the ending of the last schedule of the MAPC group, whether it is a short term or long term schedule, when the MAPC group comprises both the short term coordination scheme and the long term coordination scheme, wherein the post-coordination duration is maintained till ending of the last schedule of the MAPC group, called as guard window whether short or long when the coordination scheme is both the long term coordination scheme and the short term coordination scheme.

In an example embodiment, a coordination reject message is transmitted by the group owner AP, upon receiving the coordination notification message from the AP before the completion of the pre-coordination duration. The coordination reject message comprises a cause value indicating “not allowed” and a backoff timer parameter. The AP is restricted from sending repeated exit attempts until expiry of the backoff timer.

In an example embodiment, upon detecting a departure of another AP from the MAPC group, upon having ownership status, the instructions, when executed by the at least one processor individually or collectively, cause the AP to initiate a re-negotiation process at least by: transmitting a coordination notification message comprising a cause value indicating “re-negotiation”, redistributing coordination responsibilities among remaining APs in the MAPC group, and enforcing a restriction on further departures from the MAPC group until completion of the re-negotiation process, based on restrictions enforced during the pre-coordination period.

In an example embodiment, the pre-coordination duration is maintained until completion of the MAPC group formation procedure.

In an example embodiment, the post-coordination duration is maintained until completion of a final transmission opportunity (TXOP) schedule when the MAPC coordination scheme is based on a short-term guard window schedule.

In an example embodiment, the post-coordination duration is maintained until completion of a final service period (SP) schedule when the MAPC coordination scheme is based on a long-term guard window schedule.

In an example embodiment, the post-coordination duration is maintained until completion of the longest active schedule, when the coordination scheme comprises both short-term and long-term coordination schemes, to confirm full-cycle protection in mixed-term coordination.

In an example embodiment, the AP is permitted to exit the MAPC group during the post-coordination duration upon determining an urgency condition that overrides normal restrictions.

In an example embodiment, the instructions, when executed by the at least one processor individually or collectively, cause the AP to transmit a coordination notification message comprising a cause value indicating “exit” and a sub-cause value indicating “urgent.” The group owner AP transmits a coordination response message indicating approval to leave without applying any condition check.

In an example embodiment, the coordination notification message comprises a cause value indicating “exit” and optionally includes a sub-cause value specifying a departure reason. The group owner AP transmits a coordination response message with a cause value indicating approval or rejection based on the departure condition for introducing leniency in handling of the coordination notification.

In an example embodiment, the sub-cause value in the coordination notification message indicates a leniency condition. The group owner AP compares the remaining guard window time within the post-coordination duration with an offset value associated with the sub-cause, and allows early exit if the remaining time is less than or equal to the offset, and otherwise transmits a coordination reject message with a backoff timer parameter.

One aspect of the disclosure provides a method for wireless communication performed by an access point (AP). The method comprises detecting one or more neighbor APs of a plurality of APs. The method comprises forming a multi AP coordination (MAPC) group comprising the AP and the one or more detected neighbor APs coordinating with each other based on a coordination scheme during the pre-coordination duration. The AP and the one or more neighbor APs are restricted from leaving the MAPC group during the pre-coordination duration. The method comprises maintaining a post-coordination duration after establishment of the MAPC group for a period of time, wherein the AP and the one or more neighbor APs are allowed to exit the MAPC group conditionally during the post-coordination duration.

In an example embodiment, the method comprises determining a group owner AP has not been decided yet for the MAPC group under formation. The method comprises performing one of: (1) remaining in the MAPC group until the completion of a pre-coordination duration, when the group owner AP has not been decided yet for the MAPC group under formation, (2) requesting permission to leave the MAPC group from the decided group owner AP, when the group owner AP has been decided for the MAPC group during the pre-coordination duration, and/or (3) requesting permission to leave the MAPC group from the group owner AP during the post-coordination duration.

In an example embodiment, the requesting permission to leave the MAPC group from the decided group owner AP comprises: (1) transmitting a coordination notification message to the group owner AP before completion of the pre-coordination duration, wherein the coordination notification message comprises a cause value requesting exit from the MAPC group, and/or (2) receiving a coordination response message from the one or more neighbor APs, wherein the coordination response message comprises a cause value indicating approval to exit the MAPC group when the coordination notification message is transmitted during the post-coordination duration.

In an example embodiment, the detecting the one or more neighbor APs comprises: (1) advertising capability to participate in M-AP coordination, and/or (2) discovering the one or more neighbor APs that are capable of participating in the M-AP coordination based on the capability to participate in the M-AP coordination.

In an example embodiment, the forming the MAPC group comprises: (1) initiating a first set of dedicated signaling exchanges to negotiate and agree for one or more M-AP coordination schemes supported by the plurality of APs, and/or (2) establishing the MAPC group comprising the AP and the one or more detected neighbor APs based on the negotiated and agreed one or more M-AP coordination schemes.

In an example embodiment, the method comprises: (1) allowing the one or more neighbor APs to leave the MAPC group under formation at any time before start of a negotiation step, without requiring any related indication, and/or (2) preventing from leaving the MAPC group between the selection of group owner AP and completion of the pre-coordination step towards formation of the MAPC group to avoiding disruption to ongoing agreements or negotiations.

In an example embodiment, the method comprises determining whether a coordination scheme of the MAPC group comprises only a short-term coordination scheme, only a long-term coordination scheme, and/or a mix of both short-term coordination scheme and long-term coordination scheme. The completion of the post-coordination duration is determined based on: (1) allowing participating AP to leave the MAPC group after the ending of a last Transmission Opportunity (TXOP) schedule of the MAPC group, when the MAPC group comprises only the short-term coordination scheme, wherein the post-coordination duration is maintained till ending of the last TXOP schedule of the MAPC group, called as guard window, when the coordination scheme is the short-term coordination scheme, (2) allowing the participating AP to leave the MAPC group after the ending of the last Service Period (SP) schedule of the MAPC group, when the MAPC group comprises only the long-term coordination scheme, wherein the post-coordination duration is maintained till ending of the last SP schedule of the MAPC group, called as guard window, when the coordination scheme is the long-term coordination scheme, and/or (3) allowing the participating AP to leave the MAPC group after the ending of the last schedule of the MAPC group, whether it is a short term or long term schedule, when the MAPC group comprises both the short term coordination scheme and the long term coordination scheme, wherein the post-coordination duration is maintained till ending of the last schedule of the MAPC group, called as guard window whether short or long when the coordination scheme is both the long term coordination scheme and the short term coordination scheme.

In an example embodiment, the method comprises transmitting a coordination notification message to the group owner AP upon detection of MAPC group ownership. The message comprises a cause value indicating an exit intent. The group owner AP responds with a coordination reject message including a cause value indicating “not allowed” and a backoff timer parameter to restrict further exit attempts until completion of the pre-coordination period.

In an example embodiment, a coordination reject message is transmitted by the group owner AP, upon receiving the coordination notification message from the AP before the completion of the pre-coordination duration. The coordination reject message comprises a cause value indicating “not allowed” and a backoff timer parameter. The AP is restricted from sending repeated exit attempts until expiry of the backoff timer.

In an example embodiment, upon detecting a departure of another AP from the MAPC group, upon having ownership status, the method comprises initiating a re-negotiation process. The initiating of the re-negotiation process is performed at least by: (1) transmitting a coordination notification message comprising a cause value “re-negotiation”, (2) redistributing coordination responsibilities among remaining APs in the MAPC group, and/or (3) enforcing a restriction on further departures from the MAPC group until completion of the re-negotiation process, based on restrictions enforced during the pre-coordination period.

In an example embodiment, the pre-coordination duration is maintained until completion of the MAPC group formation procedure.

In an example embodiment, the post-coordination duration is maintained until completion of a final transmission opportunity (TXOP) schedule when the MAPC coordination scheme is based on a short-term guard window schedule.

In an example embodiment, the post-coordination duration is maintained until completion of a final service period (SP) schedule when the MAPC coordination scheme is based on a long-term guard window schedule.

In an example embodiment, the post-coordination duration is maintained until completion of the longest active schedule, when the coordination scheme comprises both short-term and long-term coordination schemes, to confirm full-cycle protection in mixed-term coordination.

In an example embodiment, the AP is permitted to exit the MAPC group during the post-coordination duration upon determining an urgency condition that overrides normal restrictions.

In an example embodiment, the AP transmits a coordination notification message comprising a cause value “exit” and a sub-cause value “urgent.” The group owner AP transmits a coordination response message indicating approval to leave without applying any condition check.

In an example embodiment, the coordination notification message comprises a cause value “exit” and optionally includes a sub-cause value specifying a departure reason. The group owner AP transmits a coordination response message with a cause value indicating approval or rejection based on the departure condition for introducing leniency in handling of the coordination notification.

In an example embodiment, the sub-cause value in the coordination notification message indicates a leniency condition. The group owner AP compares the remaining guard window time within the post-coordination duration with an offset value associated with the sub-cause, and allows early exit if the remaining time is less than or equal to the offset, and otherwise transmits a coordination reject message with a backoff timer parameter.

In an example embodiment, a non-transitory computer-readable storage medium is provided. The methods disclosed herein can be performed by one or more computer programs stored on the non-transitory computer-readable storage.

In an example embodiment, there is provided a non-statutory computer-readable storage medium storing one or more computer programs comprising instructions to perform a method for wireless communication performed by an access point (AP). The method comprises detecting one or more neighbor APs of a plurality of APs. The method comprises forming a multi AP coordination (MAPC) group comprising the AP and the one or more detected neighbor APs coordinating with each other based on a coordination scheme during the pre-coordination duration. The AP and the one or more neighbor APs are restricted from leaving the MAPC group during the pre-coordination duration. The method comprises maintaining a post-coordination duration after establishment of the MAPC group for a period of time, wherein the AP and the one or more neighbor APs are allowed to exit the MAPC group conditionally during the post-coordination duration

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. An access point (AP), comprising:
at least one processor including processing circuitry; and
memory storing instructions that, when executed by the at least one processor individually or collectively, cause the AP to:
detect one or more neighbor APs;
form a multi AP coordination (MAPC) group comprising the AP and the one or more detected neighbor APs coordinating with each other based on a coordination scheme during the pre-coordination duration, wherein the AP and the one or more neighbor APs are restricted from leaving the MAPC group during the pre-coordination duration; and
maintain a post-coordination duration after establishment of the MAPC group for a period of time, wherein the AP and the one or more neighbor APs are allowed to exit the MAPC group conditionally during the post-coordination duration.

2. The AP of claim 1, wherein the instructions, when executed by the at least one processor individually or collectively, cause the AP to:
determine a group owner AP has not been decided yet for the MAPC group under formation; and
perform one of:
remaining in the MAPC group until the completion of a pre-coordination duration, when the group owner AP has not been decided yet for the MAPC group under formation;
requesting permission to leave the MAPC group from the decided group owner AP, when the group owner AP has been decided for the MAPC group during the pre-coordination duration; and
requesting permission to leave the MAPC group from the group owner AP during the post-coordination duration.

3. The AP of 2, wherein the requesting permission to leave the MAPC group from the decided group owner AP comprises:
transmitting a coordination notification message to the group owner AP before completion of the pre-coordination duration, wherein the coordination notification message comprises a cause value requesting exit from the MAPC group; and
receiving a coordination response message from the one or more neighbor APs, wherein the coordination response message comprises a cause value indicating approval to exit the MAPC group when the coordination notification message is transmitted during the post-coordination duration.

4. The AP of claim 1, wherein the detecting the one or more neighbor APs comprises:
advertising capability to participate in M-AP coordination; and
discovering the one or more neighbor APs that are capable of participating in the M-AP coordination based on the capability to participate in the M-AP coordination.

5. The AP of claim 1, wherein the forming the MAPC group comprises:
initiating a first set of dedicated signaling exchanges to negotiate and agree for one or more M-AP coordination schemes supported by the plurality of APs; and
establishing the MAPC group comprising the AP and the one or more detected neighbor APs based on the negotiated and agreed one or more M-AP coordination schemes.

6. The AP of claim 1, wherein the instructions, when executed by the at least one processor individually or collectively, cause the AP to:
allow the one or more neighbor APs to leave the MAPC group under formation at any time before start of a negotiation step, without requiring any related indication; and
prevent from leaving the MAPC group between the selection of group owner AP and completion of the pre-coordination step towards formation of the MAPC group to avoid disruption to ongoing agreements or negotiations.

7. The AP of claim 1, wherein the instructions, when executed by the at least one processor individually or collectively, cause the AP to:
determine whether a coordination scheme of the MAPC group comprises only a short-term coordination scheme, only a long-term coordination scheme, and/or a mix of both short-term coordination scheme and long-term coordination scheme; and
wherein completion of the post-coordination duration is determined based on:
allowing participating AP to leave the MAPC group after the ending of a last Transmission Opportunity (TXOP) schedule of the MAPC group, when the MAPC group comprises only the short-term coordination scheme, wherein the post-coordination duration is maintained till ending of the last TXOP schedule of the MAPC group, called as guard window, when the coordination scheme is the short-term coordination scheme;
allowing the participating AP to leave the MAPC group after the ending of the last Service Period (SP) schedule of the MAPC group, when the MAPC group comprises only the long-term coordination scheme, wherein the post-coordination duration is maintained till ending of the last SP schedule of the MAPC group, called as guard window, when the coordination scheme is the long-term coordination scheme; and
allowing the participating AP to leave the MAPC group after the ending of the last schedule of the MAPC group, whether it is a short term or long term schedule, when the MAPC group comprises both the short term coordination scheme and the long term coordination scheme, wherein the post-coordination duration is maintained till ending of the last schedule of the MAPC group, called as guard window whether short or long when the coordination scheme is both the long term coordination scheme and the short term coordination scheme.

8. The AP of claim 1, wherein the instructions, when executed by the at least one processor individually or collectively, cause the AP to transmit a coordination notification message to the group owner AP upon detection of MAPC group ownership, the message comprising a cause value indicating an exit intent, and wherein the group owner AP responds with a coordination reject message including a cause value indicating “not allowed” and a backoff timer parameter to restrict further exit attempts until completion of the pre-coordination period.

9. The AP of claim 1, wherein a coordination reject message is transmitted by the group owner AP, upon receiving the coordination notification message from the AP before the completion of the pre-coordination duration, wherein the coordination reject message comprises a cause value indicating “not allowed” and a backoff timer parameter, wherein the AP is restricted from sending repeated exit attempts until expiry of the backoff timer.

10. The AP of claim 1, wherein upon detecting a departure of another AP from the MAPC group, upon having ownership status, the instructions, when executed by the at least one processor individually or collectively, cause the AP to initiate a re-negotiation process at least by:
transmitting a coordination notification message comprising a cause value indicating “re-negotiation”;
redistributing coordination responsibilities among remaining APs in the MAPC group; and
enforcing a restriction on further departures from the MAPC group until completion of the re-negotiation process, based on restrictions enforced during the pre-coordination period.

11. The AP of claim 1, wherein the pre-coordination duration is maintained until completion of the MAPC group formation procedure.

12. The AP of claim 1, wherein the post-coordination duration is maintained until completion of a final transmission opportunity (TXOP) schedule when the MAPC coordination scheme is based on a short-term guard window schedule.

13. The AP of claim 1, wherein the post-coordination duration is maintained until completion of a final service period (SP) schedule when the MAPC coordination scheme is based on a long-term guard window schedule.

14. The AP of claim 1, wherein the post-coordination duration is maintained until completion of the longest active schedule, when the coordination scheme comprises both short-term and long-term coordination schemes, to confirm full-cycle protection in mixed-term coordination.

15. The AP of claim 1, wherein the AP is permitted to exit the MAPC group during the post-coordination duration upon determining an urgency condition that overrides normal restrictions.

16. The AP of claim 1, wherein the instructions, when executed by the at least one processor individually or collectively, cause the AP to transmit a coordination notification message comprising a cause value indicating “exit” and a sub-cause value indicating “urgent,” and wherein the group owner AP transmits a coordination response message indicating approval to leave without applying any condition check.

17. The AP of claim 16, wherein the coordination notification message comprises a cause value indicating “exit” and optionally includes a sub-cause value specifying a departure reason, and wherein the group owner AP transmits a coordination response message with a cause value indicating approval or rejection based on the departure condition for introducing leniency in handling of the coordination notification.

18. The AP of claim 17, wherein the sub-cause value in the coordination notification message indicates a leniency condition, and wherein the group owner AP compares the remaining guard window time within the post-coordination duration with an offset value associated with the sub-cause, and allows early exit if the remaining time is less than or equal to the offset, and otherwise transmits a coordination reject message with a backoff timer parameter.

19. A method for wireless communication performed by an access point (AP), the method comprising:
detecting one or more neighbor APs of a plurality of APs;
forming a multi AP coordination (MAPC) group comprising the AP and the one or more detected neighbor APs coordinating with each other based on a coordination scheme during the pre-coordination duration, wherein the AP and the one or more neighbor APs are restricted from leaving the MAPC group during the pre-coordination duration; and
maintaining a post-coordination duration after establishment of the MAPC group for a period of time, wherein the AP and the one or more neighbor APs are allowed to exit the MAPC group conditionally during the post-coordination duration.

20. The method of claim 19, further comprising:
determining a group owner AP has not been decided yet for the MAPC group under formation; and
performing one of:
remaining in the MAPC group until the completion of a pre-coordination duration, when the group owner AP has not been decided yet for the MAPC group under formation;
requesting permission to leave the MAPC group from the decided group owner AP, when the group owner AP has been decided for the MAPC group during the pre-coordination duration; and
requesting permission to leave the MAPC group from the group owner AP during the post-coordination duration.
